(19) United States
(12) Patent Application Publication
(10) Pub. No.: US 2009/0063387 A1
(43) Pub. Date: Mar. 5, 2009

(54) Apparatus And Method For Problem Determination And Resolution

(75) Inventors: Kirk A. Beaty, Golden Bridge, NY (US); Anca Sailer, Scarsdale, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/848,258

(22) Filed: Aug. 31, 2007

(51) Int. Cl. G06N 5/00

(52) U.S. Cl. 706/50

(57) ABSTRACT

An exemplary method (which can be computer implemented) for problem determination and resolution includes the steps of detecting anomalous changes in an environment for which a problem diagnosis is to be provided, generating domain specific key words and predicates based, at least in part, on the detected anomalous changes, searching in a knowledge resolution repository for solutions related to the generated key words and predicates, and generating a particular solution for the problem, based, at least in part, on the solutions from the knowledge resolution repository

### FIELD OF THE INVENTION

The present invention relates to the electrical, electronic and computer arts, and, mole particularly, to problem determination and resolution with regard to computer hardware, software and the like.

### BACKGROUND OF THE INVENTION

Several studies on the Total Cost of Operation (TCO) show that almost half of ICO, which in turn is five to ten times the purchase price of the system hardware and software, is spent in resolving problems or preparing for imminent problems in the system, as described by David A. Wheeler, “Why Open Source Software/Free Software (OSS/FS, FLOSS, or FOSS)? Look at the Numbers!,” and A. Gillen et al, “The role of Linux in reducing the cost of enterprise computing,” IDC white paper, January 2002. Hence, the cost of problem determination and resolution represents a substantial part of operational costs. Having a well defined unified process to perform problem determination and resolution effectively and efficiently can contribute to a substantial reduction in system administration costs.

Existing art in the area of problem determination and resolution provides methodology restricted to particular products, such as “WebSphere Application Server V6 Problem Determination for Distributed Platforms,” SG24-6798-00, Redbook, 20 Nov. 2005, and “DB2 Warehouse Management: High Availability and Problem Determination Guide,” SG24-6544-00, Redbook, 22 Mar. 2002, which provide problem troubleshooting guidance from the developer perspective for IBM WEBSPHERE® and DB2® brand computer software, respectively (registered marks of International Business Machines Corporation, Armonk, N.Y., USA)(“IBM”). These guides address potential problems that have been identified in the product pre-production phase and have been categorized in error codes integrated in the product.

U.S. Pat. No. 7,039,644 of J. Hind et al. discloses a problem determination method, system and program product. Specifically, the Hind invention identifies problems with software programs by inserting compiled problem determination probes into program classes while the computer system on which the program is loaded is running. Once the probes have been inserted, the classes will be run and trace data will be generated. The trace data can be retrieved and analyzed to identify and address the problem. When the probes are no longer needed, they can be removed while the computer system continues to run.

U.S. Pat. No. 6,532,552 of D. M. Benignus et al. discloses a method and system for performing problem determination procedures in hierarchically organized computer systems. The hardware components of the data processing system are interconnected in a manner in which the components are organized in a logical hierarchy A hardware-related error occurs, and the error is logged into an error log file. At some point in time, a diagnostics process is initiated in response to the detection of the error. The logged error may implicate a particular hardware component, and the hardware component of the data processing system is analyzed using a problem determination procedure. In response to a determination that the hardware component does not have a problem, the logically hierarchical parent hardware component of the hardware component is selected for analysis. The logically hierarchical parent hardware component is then analyzed using a problem determination procedure. The method continues to analyze the logically hierarchical parent components until the root component is leached or until a faulty component is found.

U.S. Pat. No. 7,096,459 of A. Keller et al. discloses methods and apparatus for toot cause identification and problem determination in distributed systems. A technique for determining a toot cause of a condition (e.g., service outage) of at least one subject component in a computing environment comprises the following steps/operations. First, one or more components in the computing environment upon which the at least one subject component depends (e.g., antecedents) are identified. Identification comprises traversing at least a portion of a model representative of an existence of one or more relationships associated with at least a portion of components of the computing environment and which is capable of accounting for a full lifecycle (e.g., including deployment, installation and runtime) associated with at least one component of the computing environment. Then, one or mote procedures are performed in accordance with the one or more identified components to determine a condition status associated with each of the one or mole identified components. By way of example, the inventive techniques may be applied to a distributed computing environment. The computing environment may also be an autonomic computing environment.

### SUMMARY OF THE INVENTION

Principles of the present invention provide techniques, including processes, operations, and resources for problem determination and resolution in the field of information technology (IT). In one aspect, an exemplary method (which can be computer implemented) for problem determination and resolution includes the steps of detecting anomalous changes in an environment for which a problem diagnosis is to be provided, generating domain specific key words and predicates based, at least in part, on the detected anomalous changes, searching in a knowledge resolution repository fox solutions related to the generated key words and predicates, and generating a particular solution for the problem, based, at least in part, on the solutions from the knowledge resolution repository. One significant aspect of one or more embodiments of the invention is that during the problem determination process, evaluating and upgrading data in the knowledge resolution repository is based on evaluation of the particular solution.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus including a memory and at least one processor that is coupled to the memory and operative to perform exemplary method steps.

One or more embodiments of the invention may offer one or more of the following significant technical benefits: i) the generation of domain specific key terms and predicates related to the anomalous IT changes in the environment, thus guiding the search for resolution by using appropriate and relevant clauses; (ii) the integration of historical data to build a substantially complete knowledge repository which includes normal operations as well as problems with the related problem solution, organized using specific terms and predicates indexed for search; and (iii) the consolidation of PDR techniques into a unified systematic process.

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary process flow according to an aspect of the invention;

FIG. 2 depicts a computer system that may be useful in implementing one or more aspects and/or elements of the present invention;

FIG. 3 is a reproduction of FIG. 1 of U.S. patent application Ser. No. 11/675,392, renumbered for convenience;

FIG. 4 is a reproduction of FIG. 2 of U.S. patent application Ser. No. 11/675,392, renumbered for convenience; and

FIG. 5 is a reproduction of FIG. 4 of U.S. patent application Ser. No. 11/675,392.

### DETAILED DESCRIPTION OF PREFERRED EMBODIMENTS

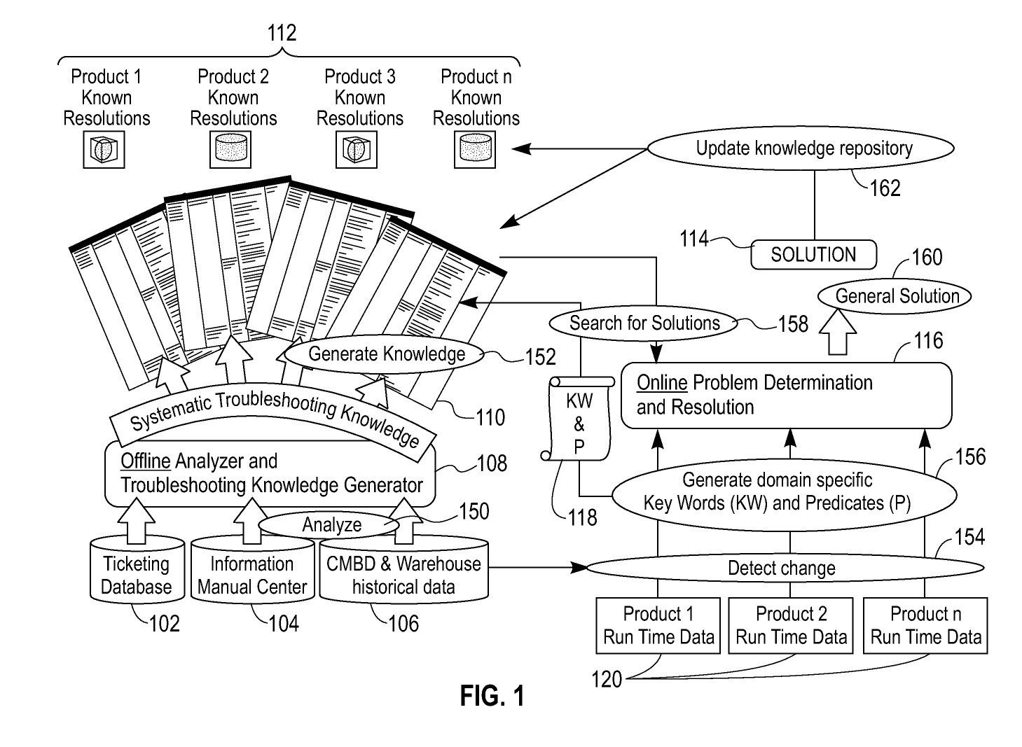

One or more embodiments of this invention provide an incremental problem determination and resolution (PDR) process that covers the operations necessary for detecting anomalies in a monitored system and providing assistance to fix the cause of the problem. FIG. 1 provides an overview of the PDR process, including two subprocesses: one offline and one online. Offline, the process periodically systematizes the historical data, such as, but not limited to, monitoring data, inventory and configuration data, manuals and problem tickets by pre-processing the historical data in a knowledge repository of normal operation behavior, correct configurations, and correlation documents correlating problem symptoms to problem resolutions. Online, the process assists the PDR through detection of anomalous IT changes by comparing the run-time behavior and configuration data to analogous historical data, generation of IT key words and predicates based on the discovered changes, and/or searching for solutions related to those key words and predicates in the repository of problem symptoms to resolutions.

Several significant aspects of the process reside in the generation of domain specific key terms and predicates related to the anomalous IT changes in the environment (thus guiding the search for resolution by using appropriate and relevant clauses), the integration of historical data to build a complete knowledge repository (which includes normal operations as well as problems with the related problem solution, organized using specific terms and predicates indexed for search), and/or the consolidation of PDR techniques into a unified systematic process. One or more embodiments of this invention provide the benefit of decreasing the cost of the current incident and problem management methodology, through systematizing existent data, knowledge, and expertise for reusability, as well as the avoidance of cost associated with problem determination by allowing for proactive problem resolution (“fix before break”) through knowledge-based early notification.

Attention should now be given to FIG. 1, which depicts an exemplary PDR process provided by one or more embodiments of the invention (each item, operation, and the information processing involved during the operational phase of the process are described hereinafter). Block 102 represents a ticketing database resource with records of problems that customers have experienced with particular services or products. These records are entered by technical helpdesk personnel and are received from the customer via an e-mail or phone call describing the issue that needs to be fixed. Technical helpdesk personnel record in a problem ticket the initial and subsequent exchanges on that issue, as well as any other information that they consider relevant to describing or solving the issue, and store it in the problem ticket database. A manual (for example, a product manual) or other information resource related to the installation, utilization, and/or troubleshooting of products or services is illustrated in Block 104. A non-limiting example of block 104 is an “InfoCenter” repository as available from IBM. Block 106 represents a database, a collection of files, and/or a file resource that stores configuration inventory, monitoring data, performance information, or events collected from the system's or service's environment. At Block 106, “CMDB” stands for a generic Configuration Management Data Base.

Block 108 represents the operations of the offline sub-process through which the data collected from Blocks 102, 104 and 106 is analyzed (block 150) and pre-processed to generate collections of systematic knowledge (block 152) around the products' and services' issues and resolutions and forming a knowledge repository. These operations can be accomplished by one or more of manual, automated, and/or semi-automated techniques and practices from, for example, artificial intelligence, natural language processing methodology, and/or data mining. Block 110 represents the systematized knowledge repository which includes a database, a collection of files, and/or a file that stores the result of the offline sub-process. Block 110 can include, for example, assets generated by block 108, such as structured problem tickets, problem determination graphs of inquiries, workflows of the tasks required for problem resolution solutions, such as they are provided by subject meter experts, or any documents relating problems to potential loot causes and solutions. The interfaces related to presentation, through which these assets are exposed, can also be included.

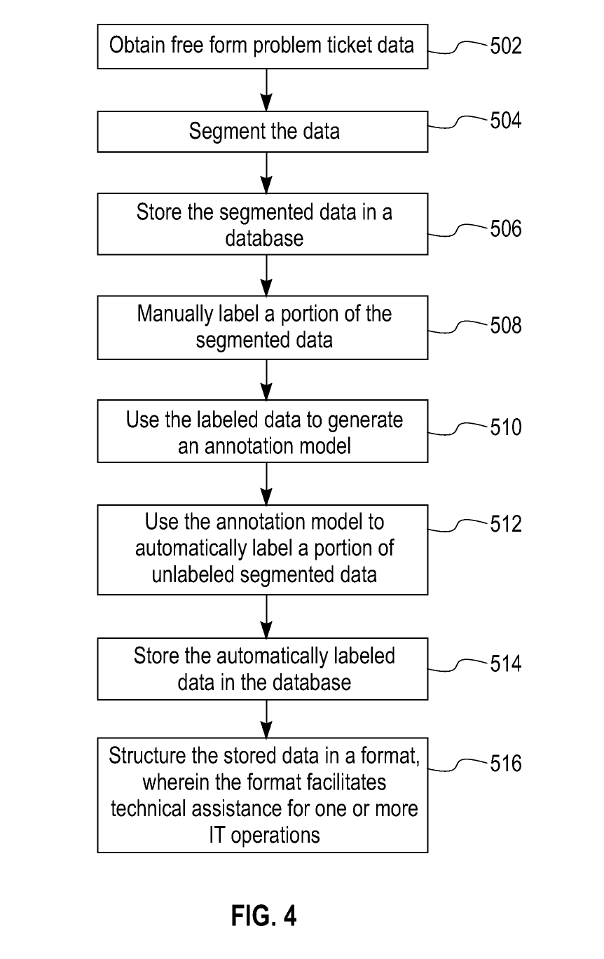

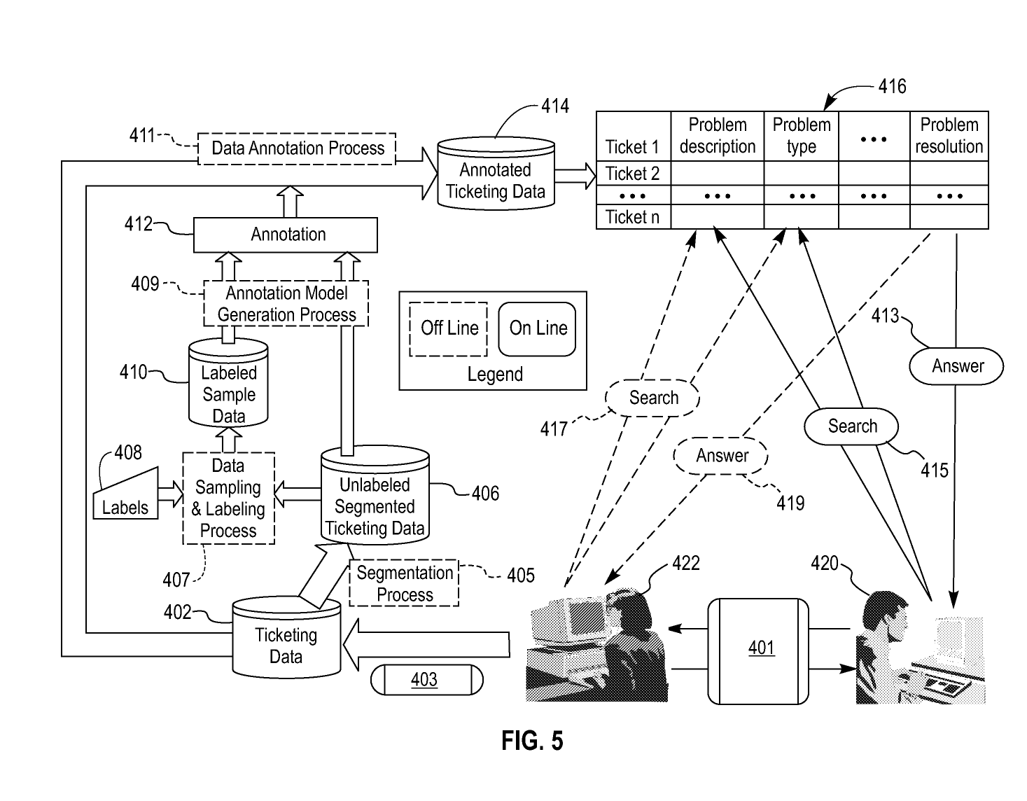

The structured problem tickets can be obtained, for example, as described in U.S. patent application Ser. No. 11/675,392, filed Feb. 15, 2007, of inventors Gautam Kar et al, entitled Method and Apparatus for Automatically Structuring Free Form Heterogeneous Data. The complete disclosure of the aforesaid U.S. patent application Ser. No. 11/675,392 is expressly incorporated herein by reference in its entirety for all purposes. Pertinent portions are reproduced hereinafter. By way of example and not limitation, see item 416 in FIG. 5 herein (FIG. 4 in the aforesaid U.S. patent application Ser. No. 11/675,392). The problem determination graphs of inquiries can be obtained, for example, as described in U.S. Pat. No. 7,171,585 of Gail et al., entitled “Diagnosing Faults And Errors From A Data Repository Using Directed Graphs,” or as described in A. Beygelzimer et al., “Test-based Diagnosis: Tree and Matrix Representations,” in Proceedings of IM 2005, or as described in D. Heckerman et al., “Decision-Theoretic Troubleshooting,” Comm. ACM 38(3):49-57 (1995).

Block 112 is an authoring environment through which the users (for example, subject matter experts, a technical helpdesk, and/or third parties) integrate their structured documents relating problems to potential root causes and solutions in the knowledge repository 110.

Block 120 can include, for example, one or more of a database, a collection of files, or a file that stores the run time data of a particular product or application. Examples of run time data are environmental conditions (for example, load, temperature, and the like), resource utilization (for example, central processing unit (CPU), memory, and the like), logs, dumps, and/or performance data (e.g., response time, jitter, and so on). Block 118 is a collection of files that contain domain specific key words and predicates generated based on changes to normal operational behavior and state detected in the failing system. The solution provided to the current problem by the online problem determination and resolution sub-process is represented in block 114, and in one or more embodiments of the invention, this solution can be presented as a workflow of problem resolution steps or tasks that a user can follow toward fixing his or her problem(s).

In one or more embodiments, the offline sub-process can be performed each time significant additional data has been collected for analysis and knowledge systematization. Given that the offline sub-process has been completed at least once, the online sub-process can perform one or more operations that will now be described. Block 154 includes detecting the changes in the environment that could have potentially led to the current issue, by leveraging the data stored in blocks 106 and 120. At block 156, the online sub-process can generate domain specific key words and predicates for block 118, based on the detected changes. In block 158, a search is made in the knowledge resolution repository 110, for solutions related to the generated key words and predicates collected in block 118. In block 160, the ultimate solution 114 for the current problem is generated. The solution 114 can be evaluated, and if necessary, the solution repository 110 and/or the authoring environment 112 can be updated with the new knowledge, as shown at block 162.

For one or more embodiments of this invention, the online PDR sub-process described above can be integrated in an existing incident management process such as in a Call Center where the main process steps cover detecting anomalies in a monitored system, locating the problems responsible for the issue, fixing the cause of the problem, and recording the problem and its resolution. Potential techniques to detect problems can range from a call to the helpdesk to report a problem, manual observation of system generated alarms, or an automatic notification of failures or performance threshold violations. The automation of one or more embodiments of the PDR change detection operation can provide the basis for automatic problem notification.

Exemplary approaches to fault localization include artificial intelligence techniques (for example, rule-based, model-based, neural networks, and/or decision trees), model traversing techniques (for example, dependency-based), and/or fault propagation techniques (for example, codebook-based, Bayesian networks, causality graphs) US Patent Application Publication number 20060101308 of Agarwal et al., entitled “System and Method for Problem Determination Using Dependency Graphs and Run-Time Behavior Models,” employs model traversing techniques and change detection. Aspects of the Agarwal et al. invention combine resource behavior models based on monitoring data analyses with resource configuration dependency information to facilitate the rapid isolation of problem causes. In one or mote embodiments of the present invention, once the knowledge about symptoms-to-problems' causes correlation is available in repositories such as 102 and 104, the offline PDR sub-process indexes the relevant symptom key words, while the online PDR sub-process can now retrieve the causes of the current issue based on the key words and predicates provided by element 118.

One or more embodiments of the PDR operation provide the “fix” to the issue that has been detected and identified. Once the knowledge about problem's causes-to-problem fix correlation is available in repositories (blocks 104 and 104), the offline PDR sub-process of the indexes the relevant root causes key words, while the online PDR sub-process can search the repository for solutions related to the current issue based on the key words and predicates provided by block 118. Typically, technical helpdesk personnel record the initial and subsequent email and call exchanges pertaining to the customer's issue, as well as any other information that they consider relevant to describing or solving the issue, by using specific ticketing management tools. As previously noted, element 102 represents a ticket repository. Another exemplary technique for recording the knowledge generated during troubleshooting is to employ the authoring environment in block 112 to record such knowledge into web forums, web-logs (“blogs”), and/or in manuals as depicted in block 104.

In view of the discussion of FIG. 1, it will be appreciated that, in general terms, an exemplary method for problem determination and resolution includes the steps of detecting anomalous changes in an environment for which a problem diagnosis is to be provided, as at block 154, and generating domain specific key words and predicates based, at least in part, on the detected anomalous changes, as at block 156. The method further includes searching in a knowledge resolution repository, such as 110, for solutions related to the generated key words and predicates, as at block 158, and generating a particular solution 114 for the problem, based, at least in part, on the solutions from the knowledge resolution repository, as shown at block 160.

In some instances, the method further includes evaluating and upgrading data in the knowledge resolution repository based on evaluation of the particular solution, as at block 162. In one or more embodiments, an additional step includes creating, offline, the knowledge resolution repository 110. The step of creating the knowledge resolution repository 110 can include, for example, the sub-step of periodically organizing available environment historical data, such as in databases 102, 104, and/or 106. Such environmental historical data may include one or mote of monitoring data, inventory and configuration data, logs, manuals, forums, and problem tickets.

In one or more instantiations, the step of creating the knowledge repository further includes the additional sub-step of analyzing and pre-processing the environmental historical data, as at block 150, to obtain the knowledge repository 110. The knowledge repository can include one or mote of data pertaining to normal operational behavior, valid configurations, problem symptom-to-problem resolution correlation documents, problem determination graphs of inquiries, workflow of tasks required for problem resolution solutions, and documents relating given problems to associated root causes and the solutions. The step of creating the knowledge repository can, in one or more embodiments, include the additional sub-step of indexing the knowledge repository 110 by the domain specific key words and predicates. The step of creating the knowledge repository 110 can be accomplished, for example, by a combination of manual, automated, and semi-automated techniques and practices; such techniques and practices can be derived from, for example, artificial intelligence, natural language processing methodology, an/or data mining. Knowledge repository 110 can be in the form of, for example, a database, a collection of files, and/or a file that stores results of the offline creation process, and can include assets and interfaces related to authoring and presentation through which the assets are loaded and exposed.

In one or more embodiments, the knowledge repository includes at least a database, and the database in turn includes assets generated by an offline analyzer and troubleshooting knowledge generator. Such assets can include problem determination graphs of inquiries, workflow of tasks required for problem resolution solutions, documents relating given problems to associated root causes and the solutions, normal operational behavior, valid configurations, and/or problem symptom to problem resolution correlation documents.

### Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

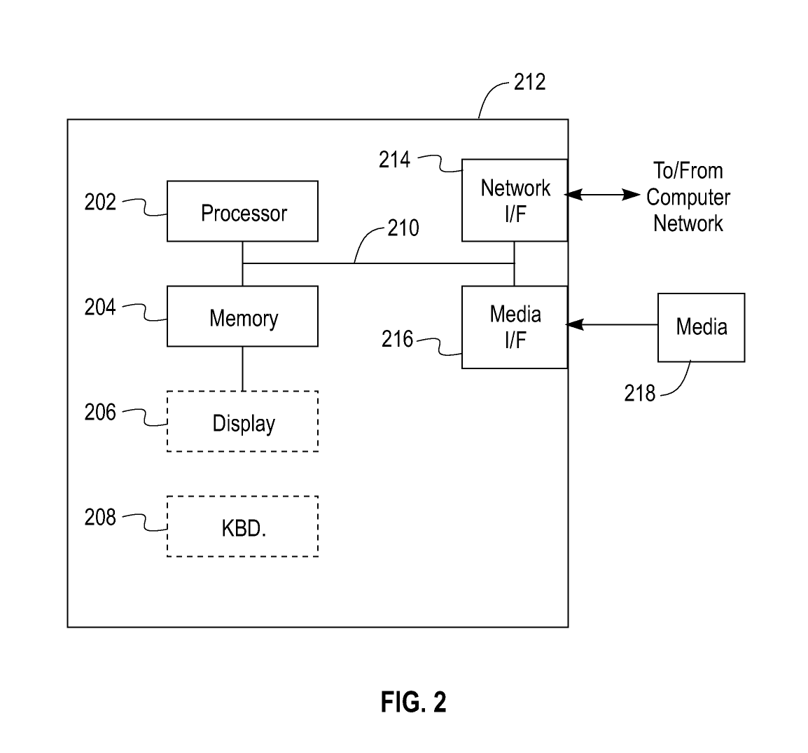

One or more embodiments can make use of software running on a general purpose computer or workstation. With reference to FIG. 2, such an implementation might employ, for example, a processor 202, a memory 204, and an input/output interface formed, for example, by a display 206 and a keyboard 208. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 202, memory 204, and input/output interface such as display 206 and keyboard 208 can be interconnected, for example, via bus 210 as part of a data processing unit 212. Suitable interconnections, for example via bus 210, can also be provided to a network interface 214, such as a network card, which can be provided to interface with a computer network, and to a media interface 216, such as a diskette or CD-ROM drive, which can be provided to interface with media 218.

Accordingly, computer software including instructions or code for performing the methodologies of the invention, as described herein, may be stored in one or mote of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 218) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a computer-readable medium include a semiconductor or solid-state memory (for example memory 204), magnetic tape, a removable computer diskette (for example media 218), a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 202 coupled directly or indirectly to memory elements 204 through a system bus 210. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 208, displays 206, pointing devices, and the like) can be coupled to the system either directly (such as via bus 210) or through intervening I/O controllers (omitted for clarity).

Network adapters such as network interface 214 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

Reproduction of Passages from U.S. patent application Ser. No. 11/675,392, Filed Feb. 15, 2007, of Inventors Gautam Kar et al., Entitled Method and Apparatus for Automatically Structuring Free Form Heterogeneous Data

In another aspect of the invention, a technique for automatically structuring free form problem ticket data for facilitating technical assistance for IT operations includes the following steps. Free form problem ticket data is obtained. The data is segmented, and the segmented data is stored in a database. A portion of the segmented data is manually labeled, and the labeled data is used to generate an annotation model. The annotation model is used to automatically label a portion of unlabeled segmented data. The automatically labeled data is stored in the database. Also, the stored data is structured in a format, wherein the format facilitates technical assistance for one or more IT operations.

Principles of the present invention include techniques to automatically structure free form heterogeneous textual data in order to enable an enhanced search system. The techniques include identifying specific features of patterns discovered in the free form text through machine learning procedures. As used herein, “free form data” refers to data that does not reside in fixed locations. By way of example, free form data may include unstructured text in a word processing document. Also, as used herein, “trouble ticket (TT)” as well as “problem ticket” refer to a mechanism used to track the detection, reporting, and resolution of'some type of problem.

Principles of the present invention identify the structure of free form textual data rich in various descriptions, steps, analysis, interleaved with data identification details and content that is not useful for search purpose (for example, separators). Therefore, one or more embodiments of the present invention facilitate searching systems that distinguish the relevant parts of free form textual data from the irrelevant portions for various purposes and objectives. Principles of the present invention provide an approach for automatically identifying key information structures in a free form textual problem ticket.

An exemplary embodiment of the present invention utilizes a set of supervised and semi-supervised learning algorithms and processes to carry out the techniques described below. Free text is segmented into one or more units by identifying the punctuation, one or more line breaks in the free form data, or by identifying parts of speech in the data, particularly the verbs. The segmenting step transforms the free text into a format that can be labeled, and determines the text format that will ultimately be provided to the one or more users. The segmented units are automatically labeled based on machine learning techniques, so that each unit of the free form data is associated with one label that indicates the information type of the unit. The labeling step annotates the data and makes it possible to impose structure on the free form TT data.

Once the structure of a TT set has been identified through manual/automatic analysis of the data and imposed through automatic labeling, the TT set can be represented by a format such as, for example, a table, an extensible markup language (XML) format, or other structured formats. The structured data format can be used, for example, to facilitate search and analysis operations that cannot be performed effectively on the initial free form data. The structured data can also be used, for example, to provide a better understanding of the contents in a ticket to human beings, as well as to provide a more effective representation to computers. An example of such an analysis is the detection of individual, concrete steps taken by individuals (for example, technical employees) to resolve a particular customer issue. As noted above, in existing approaches, similar analysis steps would be buried in the free form text of a ticket and could not, in general, be reused easily.

Furthermore, in contrast to the disadvantages of existing approaches, principles of the present invention provide automated and generic techniques to generate feature-based complex models (that is, models that make use of one or more feature sets) to identify the relevant structures of the TT. An exemplary embodiment of the present invention provides precise acquisition of information from each ticket, including, for example, differentiation of problem description from root cause analysis, resolution steps, etc. Also, a preferred embodiment of the invention is capable of being used with complex data. A learning process is generated by a machine learning model and thus, can effectively function with a wide range of complex interleaved unit data types and text dependencies. As noted above, existing approaches utilize rule-based heuristic methods, and ate effective only on data with dominating and obvious features.

Principles of the present invention ate based on common automatic learning, and therefore it is to be appreciated by one skilled in the art that they are applicable to data sets other than those described in the specific implementations herein. For example, most of the basic features discovered during the evaluation of a particular data set can be inherited, and new features can be easily added.

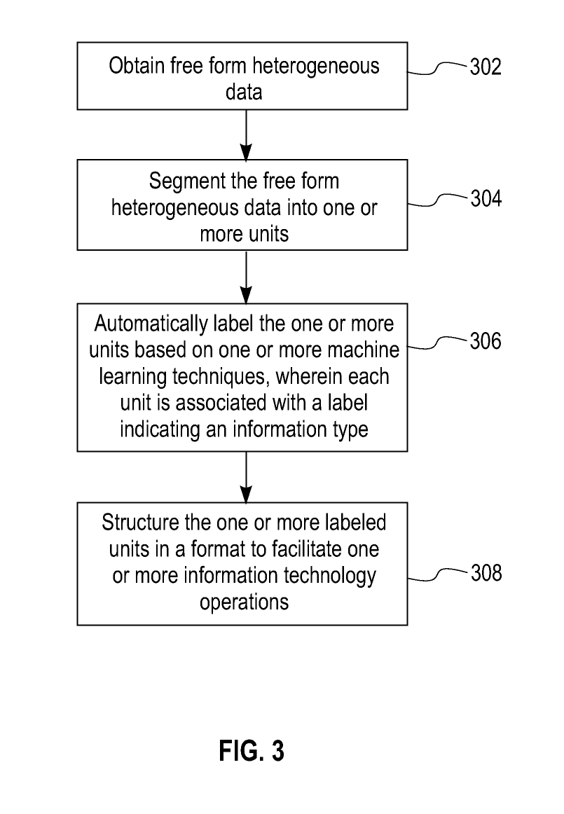

FIG. 3 shows a flow diagram illustrating a method for automatically structuring free form heterogeneous data, according to one embodiment of the invention. Step 302 includes obtaining free form heterogeneous data. Step 304 includes segmenting the free form heterogeneous data into one ox more units. Step 306 includes automatically labeling the one or more units based on one or more machine learning techniques, wherein each unit is associated with a label indicating an information type. Step 308 includes structuring the one or more labeled units in a format to facilitate one or more IT operations. Structuring the one or mote labeled units in a format may include facilitating processing of existing free form data and newly obtained free form data.

FIG. 4 shows a flow diagram illustrating a method for automatically structuring free form problem ticket data for facilitating technical assistance for information technology (IT) operations, according to one embodiment of the invention. Step 502 includes obtaining free form problem ticket data. Step 504 includes segmenting the data. Step 506 includes storing the segmented data in a database. Step 508 includes manually labeling a portion of the segmented data. Exemplary labels may include, for example, abstract, blank line, contact information (info), important step, no data, problem context problem description, problem type, root cause, severity level, and unimportant step.

Also, step 510 includes using the labeled data to generate an annotation model. Generating an annotation model may include generating a semi-supervised learning process based on one or more machine learning techniques. An exemplary machine learning technique may include a conditional random fields (CRFs) learning technique. Step 512 includes using the annotation model to automatically label a portion of unlabeled segmented data. Step 514 includes storing the automatically labeled data in the database. Step 516 includes structuring the stored data in a format, wherein the format facilitates technical assistance for one or more IT operations. Technical assistance for an IT operation may include processing existing free form problem ticket data offline, and may also include processing newly obtained free form problem ticket data online.

FIG. 5 is a diagram illustrating an exemplary system for automatically structuring free form problem ticket data for facilitating technical assistance for information technology (IT) operations, according to one embodiment of the invention.

As illustrated in FIG. 5, there is an interaction 401 between a user 420 and a technical support individual 422 (for example, a remote technical assistance individual). A ticket is recorded by the technical support individual 422 at step 403 into a database, a collection of files, or a file 402 that stores the original ticketing data. Element 402 is a repository where the helpdesk personnel and the remote technical assistance individual record the actions taken during their investigation of a customer's issues.

The segmentation process in step 405 includes the data processing step that segments the free form ticketing data into units. Principles of the present invention may leverage different ways to achieve segmentation. For example, segmentation can be based on sentences by identifying the punctuation in the free form data. Also, segmentation can be based on identifying one or more line breaks in the data. Additionally, segmentation can be based on identifying parts of speech in the data. In an exemplary embodiment, segmentation can be based on identifying one or more verbs in the data.

The unlabeled segmented ticketing data generated by the segmenting process in step 405 is stored in a database, a collection of files, or a file represented by element 406. A randomly small portion of this data is handled during the data sampling and labeling process in step 407, a process which involves manual TT sampling and labeling. Potential exemplary labels 408 ale described in Table 1 below.

TABLE 1
Description of potential labeling:

| Label | Label Description |
|---|---|
| Abstract | Lines related to the problem abstract. |
| Blankline | Lines that contain no visible text. |
| ContactInfo | Lines that contain remote assistant contact related |
| | records. |
| ImportantStep | Lines that contain the important resolution steps |
| | followed during the problem solving process. |
| Nodata | Lines of text that have no association with the |
| | problem, the resolution, or the call information. |
| ProblemContext | Lines of text containing any information related to |
| | the environment where the problem occurs and |
| | to the environment configuration. |
| ProblemDescription | Lines that describe the problem. |
| ProblemType | Lines of text that contain the categorization |
| | information of software and hardware problems. |
| RootCause | Lines containing diagnostic analysis of the problem. |
| SeverityLevel | Lines contain the severity level information that |
| | reflects the degree of emergency of the |
| | customer problem. |
| UnimportantStep | Lines describing steps unimportant from the |
| | problem resolution perspective, which the remote |
| | assistant may take such as, for example, “wait |
| | for customer feedback” |

Element 410 represents a database, a collection of files, or a file that stores the labeled sampled TT data generated by the data sampling and labeling process in step 407. Based on the manually labeled data stored in element 410, the annotation model generation process in step 409 trains the annotation model. In an exemplary embodiment of the present invention, the annotation model generation process in step 409 is a semi-supervised learning process based on machine learning techniques.

In a preferred embodiment of the invention, a recent machine learning technique, Conditional Random Fields (CRFs), is used because of its proven effectiveness on real-world tasks in various fields. As way of example and not limitation, o−(o₁,o₂, . . ., o₇) can be a sequence of units of text in a ticket. Let S be a set of finite state machine (FSM) states, each of which is associated with a label, l ε L, such as, for example, <ProblemDescription>, <ImportantStep>, etc. Let s=(s₁,s₂, . . . s₇) be some sequence of states. CRFs define the conditional probability of a state sequence given an input sequence as:

$${P}_{Λ} ( s \vert o ) = \frac{1}{{Z}_{o}} exp ( {\sum }_{t = 1}^{T} {\sum }_{k} {λ}_{k} {f}_{k} ( {s}_{t - 1} , {s}_{t} , o , t ) ) , \qquad ( 1 )$$

where Zₒ is a normalization factor over all state sequences, fₖ(sₜ₋₁,sₜ,o,t) is an arbitrary feature function over its arguments, and λₖ is a learned weight for each feature function.

In generating an exemplary model to be used to label data, a feature function may, for example, be defined to have the value “0” in most cases, and the value “1” if and only if sₜ₋₁ is state #1 (for example, labeled <ProblemDescription>), sₜ is state #2 (for example, labeled <Error>), and the observation at position t in o is a line of text containing long strings separated by a couple of gaps. Higher λ weights make their corresponding FSM transitions more likely, so the weight λₖ in this example should be positive since long strings often appear in lines of system error messages.

In the exemplary embodiment of the present invention which adopts Conditional Random Fields, the learning process' target is to evaluate λₖ. CRFs define the conditional probability of a label sequence based on total probability over the state sequences as follows:

$${p}_{Λ} ( l \vert o ) = {\sum }_{s : 𝓁 ( s ) = l} {p}_{Λ} ( s \vert o ) , \qquad ( 2 )$$

where l(s) is the sequence of labels corresponding to the labels of the states in sequence s. The normalization factor (also known in statistical physics as the partition function) is the sum of the “scores” of all possible state sequences, as follows:

$${Z}_{o} = {\sum }_{s ∈ {S}^{2}} exp ( {\sum }_{t = 1}^{T} {\sum }_{k} {λ}_{k} {f}_{k} ( {s}_{t - 1} , {s}_{t} , o , t ) )$$

The unlabeled TT data in element 406, other then the TT data sampled for populating element 409, can be used for advanced enhancing of the automatic-labeling model by semi-supervised learning techniques (for example, Blum, A., Mitchell, T. Combining labeled and unlabeled data with co-training. COLT: Proceedings of the Workshop on Computational Learning Theory, pages 92-100 (July 1998), as well as U.S. patent application Ser. No. 11/675,396 of Gautam Kar et al., identified as Attorney Docket No. YOR920070015US1, filed on Feb. 15, 2007 (concurrently with U.S. patent application Ser. No. 11/675,392), and entitled “Method and Apparatus for Automatically Discovering Features in Free Form Heterogeneous Data,” the disclosures of which are expressly incorporated by reference herein in their entirety for all purposes).

An annotation model 412 is generated via the training process in step 409 from the labeled TT data in element 410. The annotation model 412 can be used to automatically determine the labels for the units of the remaining unlabeled TT data in element 406.

Element 414 represents a database, a collection of files, or a file that stores the automatically annotated TT data initially stored unlabeled in element 402 and transformed using the model in element 412. The automatic annotation process in step 411 can be executed, for example, offline, as illustrated in FIG. 4, by processing current existing data. It can also be done online by, for example, directly processing newly recorded TT data. Thus, when a technical individual (for example, a remote technical assistant) closes a ticket, the ticket can be automatically annotated based on the annotation model 412, and stored into element 414 with its labeled structure. In the latter exemplary embodiment, element 402 may stole only the open tickets, that is, the tickets containing recording of problems still under investigation, while element 414 stores updated annotated TT data.

Element 416 is an example of structured TT data representation. As illustrated in FIG. 4, a structured TT data representation 416 may be a table in a relational database. The structured TT data representation may also be in the form of, for example, an extensible markup language (XML) format.

Once data is annotated, the structure associated with the labels allows the relevant TT data to be used in many applications. By way of example, such applications may include applications associated with providing remote technical support for IT products, such as, for example, hardware, software, network elements, etc. For instance, FIG. 4 illustrates how it can be used by a user 420 when a problem happens, to quickly look up a table 416 via step 415 to find out solutions in step 413 to similar problems encountered by other users. Helpdesk personnel 422 can also search element 416 via step 417 to reuse previously applied solutions. If there is a match, the resolution is known and conveyed to the helpdesk personnel 422 via step 419. If there is no match, the usual path of involving a call-taker can implemented by the helpdesk personnel 422. In one or more embodiments of the present invention, the user-delivered information has information related to the fields in element 416, such as, for example, problem type and problem description.

The structured TT data can also be used to discover the most frequently recurring problems, as well as to identify simple problems that may be resolved automatically. In an exemplary embodiment of the invention, such insights can be leverage in the development of an automatic problem determination system by, for example, arranging each verb and the corresponding objects with an important-action label, and associating each verb with certain system operations.

One or mote embodiments of the present invention can be implemented as a computer program, such as, for example, a computer program written in the Java or C programming language.

What is claimed is:

1. A method for problem determination and resolution, said method comprising the steps of:
detecting anomalous changes in an environment for which a problem diagnosis is to be provided;
generating domain specific key words and predicates based, at least in part, on said detected anomalous changes;
searching in a knowledge resolution repository for solutions related to said generated key words and predicates; and
generating a particular solution for said problem, based, at least in part, on said solutions from said knowledge resolution repository.

2. The method of claim 1, evaluating and upgrading data in said knowledge resolution repository based on evaluation of said particular solution.

3. The method of claim 2, further comprising the additional step of creating, offline, said knowledge resolution repository.

4. The method of claim 3, wherein said step of creating said knowledge repository comprises the sub-step of periodically organizing available environment historical data.

5. The method of claim 4, wherein said available environmental historical data comprises at least one of monitoring data, inventory and configuration data, logs, manuals, forums, and problem tickets.

6. The method of claim 4, wherein said step of creating said knowledge repository further comprises the additional sub-step of analyzing and pre-processing said environmental historical data to obtain said knowledge repository.

7. The method of claim 6, wherein said knowledge repository comprises data pertaining to normal operational behavior, valid configurations, and problem symptom to problem resolution correlation documents.

8. The method of claim 7, wherein said knowledge repository further comprises problem determination graphs of inquiries, workflow of tasks required for problem resolution solutions, and documents relating given problems to associated root causes and said solutions.

9. The method of claim 6, wherein said step of creating said knowledge repository further comprises the additional sub-step of indexing said knowledge repository by said domain specific key words and predicates.

10. The method of claim 3, wherein said step of creating said knowledge repository is accomplished by a combination of manual, automated, and semi-automated techniques and practices.

11. The method of claim 10 wherein said techniques and practices are derived from at least one of artificial intelligence, natural language processing methodology, and data mining.

12. The method of claim 3, wherein said knowledge repository comprises at least one of a database, a collection of files, and a file that stores results of said offline creation.

13. The method of claim 11, wherein said knowledge repository comprises at least a database and wherein said database in turn comprises assets generated by an offline analyzer and troubleshooting knowledge generator, said assets comprising at least one of problem determination graphs of inquiries, workflow of tasks required for problem resolution solutions, documents relating given problems to associated root causes and said solutions, normal operational behavior valid configurations, and problem symptom to problem resolution correlation documents.

14. The method of claim 3, wherein said knowledge repository comprises assets and interfaces related to authoring and presentation through which said assets are loaded and exposed.

15. A computer program product comprising a computer useable medium including computer usable program code for problem determination and resolution, said computer program product including:
computer usable program code for detecting anomalous changes in an environment for which a problem diagnosis is to be provided;
computer usable program code for generating domain specific key words and predicates based, at least in part, on said detected anomalous changes;
computer usable program code for searching in a knowledge resolution repository for solutions related to said generated key words and predicates; and
computer usable program code for generating a particular solution for said problem, based, at least in part, on said solutions from said knowledge resolution repository.

16. The computer program product of claim 15, further comprising computer usable program code for evaluating and upgrading data in said knowledge resolution repository based on evaluation of said particular solution.

17. The computer program product of claim 15, further comprising computer usable program code fur creating, offline, said knowledge resolution repository.

18. An apparatus fur problem determination and resolution, the apparatus comprising:
a memory; and
at least one processor, coupled to the memory, operative to:
detect anomalous changes in an environment for which a problem diagnosis is to be provided;
generate domain specific key words and predicates based, at least in part, on said detected anomalous changes;
search in a knowledge resolution repository for solutions related to said generated key words and predicates; and
generate a particular solution for said problem, based, at least in part, on said solutions from said knowledge resolution repository.

19. The apparatus of claim 18, wherein said processor is further operative to evaluate and upgrade data in said knowledge resolution repository based on evaluation of said particular solution.

20. The apparatus of claim 18, wherein said processor is further operative to create, offline, said knowledge resolution repository.
